(19) United States
(12) Patent Application Publication
(10) Pub. No.: US 2024/0246826 A1
(43) Pub. Date: Jul. 25, 2024

(54) C/SIC COMPOSITE PARTICLES AND THEIR MANUFACTURING METHOD, ELECTRODE CATALYST AND POLYMER ELECTROLYTE FUEL CELL COMPRISING THE C/SIC COMPOSITE PARTICLES

(71) Applicants: KABUSHIKI KAISHA TOYOTA CHUO KENKYUSHO, Nagakute-shi, Aichi-ken (JP); TOYOTA JIDOSHA KABUSHIKI KAISHA, Toyota-shi, Aichi-ken (JP); CATALER CORPORATION, Kakegawa-shi, Shizuoka-ken (JP)

(72) Inventors: Tomohiro TAKESHITA, Nagakute-shi (JP); Kazuhisa YANO, Nagakute-shi (JP); Rui IMOTO, Fujisawa-shi (JP); Noriyuki KITAO, Susono-shi (JP); Kenji YAMAMOTO, Hamamatsu-shi (JP); Godai KITAYAMA, Kakegawa-shi (JP)

(73) Assignees: KABUSHIKI KAISHA TOYOTA CHUO KENKYUSHO, Nagakute-shi, Aichi-ken (JP); TOYOTA JIDOSHA KABUSHIKI KAISHA, Toyota-shi, Aichi-ken (JP); CATALER CORPORATION, Kakegawa-shi, Shizuoka-ken (JP)

(21) Appl. No.: 18/576,059

(22) PCT Filed: Jun. 20, 2022
(86) PCT No.: PCT/JP2022/024474

§ 371 Date: Jan. 2, 2024

(30) Foreign Application Priority Data
Jul. 7, 2021 (JP) 2021-113188

(51) Int. Cl. C01B 32/97; H01M 4/90; H01M 8/10

(52) U.S. Cl. CPC C01B 32/97; H01M 4/9083; H01M 8/10; C01P 2002/08; C01P 2004/62; C01P 2004/64; C01P 2006/16; C01P 2006/40; H01M 2008/1095

(57) ABSTRACT

[Problem] To provide a practical solid polymer fuel cell having high cell performance and excellent durability.

[Means for solving] The polymer electrolyte fuel cell according to the present invention includes: a membrane electrode assembly in which electrodes each including a catalyst layer are joined to both surfaces of an electrolyte membrane; and a peroxide decomposition catalyst which is fixed to the electrolyte membrane and/or the electrodes and includes a hardly soluble carbide, a boride, and/or a silicide. The peroxide decomposition catalyst preferably contains a carbide, a boride and/or a silicide of a rare earth element, a transition metal element or a typical metal element.

### TECHNICAL FIELD

The present invention relates: to C/SiC composite particles, a method for manufacturing the C/SiC composite particles, an electrode catalyst, and a polymer electrolyte fuel cell; more specifically to C/SiC composite particles in which SiC particles are distributed on inner wall surfaces of porous carbon particles and an electrode catalyst and a polymer electrolyte fuel cell including the C/SiC composite particles as a catalyst carrier.

### BACKGROUND ART

A polymer electrolyte fuel cell has a Membrane Electrode Assembly (MEA) in which electrodes containing catalysts (catalyst layers) are bonded to both sides of an electrolyte membrane. A gas diffusion layer is usually arranged outside a catalyst layer. Further, a current collector (separator) with a gas flow path is arranged outside the gas diffusion layer. A polymer electrolyte fuel cell usually has a structure (a fuel cell stack) in which a plurality of unit cells, each of the unit cells including such an MEA, gas diffusion layers, and current collectors, are stacked.

It is known that, in the operation of a polymer electrolyte fuel cell, hydrogen peroxide is generated in a cathode catalyst layer or an anode catalyst layer, the hydrogen peroxide becomes an OH radical by a Fenton reaction, and the OH radical deteriorates an electrolyte in an MEA. The deterioration of an electrolyte causes the endurance or the power generation performance of a fuel cell to deteriorate. In this context, various proposals have heretofore been made in order to solve the problem.

For example, Patent Literature 1 discloses a membrane electrode assembly obtained by:
(a) manufacturing a cathode transfer electrode containing NbC powder having an average particle diameter of 1 to 3 microns and an anode transfer electrode not containing NbC powder;
(b) manufacturing an electrolyte membrane containing SiC powder having an average particle diameter of 50 nm; and
(c) transferring the cathode transfer electrode and the anode transfer electrode to both sides of the electrolyte membrane.

The literature describes that:
(A) certain carbides, borides, and silicides are relatively stable in water of a high temperature and a low pH and have a relatively high peroxide decomposition function; and
(B) electrolyte deterioration caused by a peroxide radical can be suppressed by fixing them to an electrolyte membrane and/or an electrode.

As described in Patent Literature 1, the electrolyte deterioration caused by a peroxide radical can be suppressed to some extent by adding a carbide, a boride, or a silicide having a peroxide decomposition function to an electrolyte membrane and/or a catalyst layer.

A peroxide, however, is mainly generated on the surfaces of catalyst particles. By a method of adding fine particles into an electrolyte membrane or a catalyst layer therefore, it may happen sometimes that generated hydrogen peroxide cannot be decomposed efficiently and deterioration suppression effect of an electrolyte is insufficient.

### CITATION LIST

### Patent Literature

PTL 1: Japanese Unexamined Patent Application Publication No. 2006-107967

### SUMMARY OF INVENTION

### Technical Problem

A problem to be solved by the present invention is to provide C/SiC composite particles and a method for manufacturing the C/SiC composite particles that are capable of suppressing electrolyte deterioration caused by a peroxide radical when the C/SiC composite particles are used as a catalyst carrier for a fuel cell.

Another problem to be solved by the present invention is to provide an electrode catalyst and a polymer electrolyte fuel cell including such C/SiC composite particles.

### Solution to Problem

In order to solve the above problems, C/SiC composite particles according to the present invention include:
porous carbon particles; and
SiC particles distributed on inner wall surfaces of pores of the porous carbon particles.

The method for manufacturing C/SiC composite particles according to the present invention includes:
a first process of preparing porous silica particles acting as a template;
a second process of precipitating carbon in pores of the porous silica particles and obtaining a silica/carbon composite A;
a third process of removing a part of the silica from the silica/carbon composite A and obtaining a silica/carbon composite B; and
a fourth process of obtaining the C/SiC composite particles according to the present invention by heat-treating the silica/carbon composite B and graphitizing the carbon and simultaneously reacting the silica with a part of the carbon and generating SiC.

The electrode catalyst according to the present invention includes:
the C/SiC composite particles according to the present invention; and
catalyst particles supported on the surfaces of the C/SiC composite particles.

Further, the polymer electrolyte fuel cell according to the present invention includes the electrode catalyst according to the present invention as a cathode catalyst or an anode catalyst.

### Advantageous Effects of Invention

When a part of silica is removed from a silica/carbon composite and the silica/carbon composite is heat-treated at a relatively high temperature, the carbon is graphitized, simultaneously the silica reacts with the carbon, and SiC is generated. As a result, a C/SiC composite in which SiC particles are distributed on inner wall surfaces of pores of porous carbon particles is obtained.

SiC particles have the function of decomposing hydrogen peroxide into harmless water and oxygen. When catalyst particles are supported on the surfaces (for example, inner wall surfaces of pores) of C/SiC composite particles therefore, even though the hydrogen peroxide is generated on the surfaces of the catalyst particles, the SiC particles existing in the pores decompose the hydrogen peroxide rapidly. As a result, it is possible to suppress the deterioration of an electrolyte caused by peroxide radicals.

Further, a decomposition product (for example, sulfonic acid anion) generated by the deterioration of an electrolyte can be a poisoning source of catalyst particles. In the case where the catalyst particles are supported in the pores of C/SiC composite particles in contrast, the poisoning of the catalyst particles caused by the poisoning source can be suppressed.

### BRIEF DESCRIPTION OF DRAWINGS

FIG. 1 is pore diameter distributions of C/SiC composite particles obtained in Examples 1 and 2 and Comparative Example 1.

FIG. 2 is a graph showing a relationship between an Si mass rate (an Si mass per unit surface area of C/SiC composite particles) and a specific surface area in C/SiC composite particles.

FIG. 3A is I-V characteristics before and after an endurance test of a unit cell obtained in Example 3, FIG. 3B is I-V characteristics before and after an endurance test of a unit cell obtained in Example 4, and FIG. 3C is I-V characteristics before and after an endurance test of a unit cell obtained in Comparative Example 2.

FIG. 4 is a graph showing a relationship between an Si mass rate (an Si mass per unit surface area of C/SiC composite particles) and an activity retention ratio.

FIG. 5A is a CV during the endurance test of a unit cell obtained in Example 3, FIG. 5B is a CV during the endurance test of a unit cell obtained in Example 4, and FIG. 5C is a CV during the endurance test of a unit cell obtained in Comparative Example 2.

### DESCRIPTION OF EMBODIMENTS

An embodiment of the present invention is explained hereunder in detail.

### (1. C/SiC Composite Particles)

C/SiC composite particles according to the present invention include: porous carbon particles; and

SiC particles distributed on inner wall surfaces of pores of the porous carbon particles.

### (1.1. Structure)

C/SiC composite particles according to the present invention can be obtained by:
(a) manufacturing porous silica particles;
(b) manufacturing a silica/carbon composite A by introducing a carbon source into pores of the porous silica particles and carbonizing the carbon source;
(c) removing a part of the silica from the silica/carbon composite A; and
(d) baking a silica/carbon composite B formed by removing the part of the silica at a high temperature.

C/SiC composite particles obtained in this way have a structure in which SiC particles are distributed on inner wall surfaces of pores of porous carbon particles.

On this occasion, the outer shape of porous carbon particles is nearly equal to the outer shape of porous silica particles used as a template. For example, when spherical porous silica particles are used as a template, spherical porous carbon particles are obtained.

Otherwise, when porous silica particles having a structure in which a plurality of primary particles are connected in a bead shape (hereinafter, the structure is referred to also as a “connected structure”) are used as a template, porous carbon particles having the connected structure are obtained. On this occasion, the primary particles may be spherical particles or particles having distorted shapes with aspect ratios of about 1.1 to 3.

SiC particles are formed by reacting SiO₂ remaining in pores of porous carbon particles with carbon constituting pore walls of the porous carbon particles. When the amount of carbon reacting with SiO₂ is relatively small therefore, the structure of the pores of the porous carbon particles takes a structure nearly corresponding to the structure of the pore walls of a template (porous silica particles). On the other hand, when the amount of carbon reacting with SiO₂ is relatively large, the pore structure of the porous carbon particles collapses and may sometimes change to a structure different from the structure of pore walls of a template.

### (1.2. Surface Functional Group)

C/SiC composite particles may further include a —OH group and/or a —COOH group which are/is introduced on the surfaces of porous carbon particles.

The “surfaces of porous carbon particles” cited here means the outer surfaces and/or the inner surfaces of pores of the porous carbon particles.

When catalyst particles are supported on the surfaces of C/SiC composite particles, if a —OH group and/or a —COOH group exist/exists on the surfaces of porous carbon particles, fine catalyst particles can be supported on the surfaces of the porous carbon particles. The concentration of such a functional group on the surfaces of the porous carbon particles is not particularly limited and an optimum concentration can be selected in accordance with a purpose.

### (1.3. Physical Property Values)

### (1.3.1. Mode Diameter of Pores)

A “mode diameter of pores” means a pore diameter where pore volume is maximum (most frequent peak value) when adsorption side data of a nitrogen adsorption isotherm of porous carbon particles in which SiC particles are dispersed on the inner walls of pores (namely, C/SiC composite particles) is analyzed by a BJH method.

If a mode diameter of pores of porous carbon particles is too small, catalyst particles are hardly supported in the pores. A desirable mode diameter of pores therefore is 1.5 nm or more. A more desirable mode diameter of pores is 2.0 nm or more.

On the other hand, if a mode diameter of pores is too large, a poisoning substance is likely to intrude into the pores and the activity of catalyst particles supported in the pores may sometimes be deteriorated. A desirable mode diameter of pores therefore is 5.0 nm or less. A more desirable mode diameter of pores is 4.0 nm or less.

### (1.3.2. Average Primary Particle Diameter of SiC Particles)

As stated above, SiC particles are formed by reacting SiO₂ remaining in pores of porous carbon particles with carbon constituting pore walls of the porous carbon particles. An average primary particle diameter of SiC particles therefore is usually not larger than the mode diameter of pores of porous carbon particles. By optimizing manufacturing conditions, an average primary particle diameter of SiC particles is smaller than the mode diameter of pores of porous carbon particles.

### (1.3.3. Si Mass Rate)

A “Si mass rate” means a rate of the mass of Si per unit surface area of porous carbon particles in which SiC particles are distributed on the inner walls of pores (namely, C/SiC composite particles).

Most of Si contained in C/SiC composite particles exists as SiC particles. A high Si mass rate means that the amount of SiC particles distributed on the inner wall surfaces of pores is large. Since SiC particles have a function of decomposing hydrogen peroxide, the hydrocarbon peroxide decomposition ability of C/SiC composite particles increases as an Si mass rate increases. In order to obtain such an effect, an Si mass rate has to be more than 0 mg/m². An Si mass rate is desirably 0.4 mg/m² or more and more desirably 1.0 mg/m² or more.

On the other hand, a high Si mass rate means that more carbon is consumed for generating SiC. If an Si mass rate is too high therefore, pores in porous carbon particles may sometimes disappear. A desirable Si mass rate is therefore 6.8 mg/m² or less. An Si mass rate is more desirably 3.3 mg/m² or less and yet more desirably 1.6 mg/m² or less.

### (1.3.4. Average Primary Particle Diameter)

An “average primary particle diameter” of C/SiC composite particles means an average value of the particle diameters of the primary particles of the C/SiC composite particles and means an average value of the lengths in short axis directions of 100 particles arbitrarily extracted from an SEM image.

If an average primary particle diameter of C/SiC composite particles is too small, gaps between primary particles are small and transfer resistance of reaction gases (hydrogen and oxygen) may sometimes be large. Further, the drainage of water generated by the reaction becomes poor and hence cell performance may sometimes be deteriorated. A desirable average primary particle diameter therefore is 50 nm or more. A more desirable average primary particle diameter is 75 nm or more.

On the other hand, if an average primary particle diameter of C/SiC composite particles is too large, moving distances of protons and reaction gases (hydrogen and oxygen) in the interiors of the primary particles are increased and transfer resistance may sometimes be increased. Further, the drainage of water generated by the reaction becomes poor and hence cell performance may sometimes be deteriorated. A desirable average primary particle diameter therefore is 200 nm or less. An average primary particle diameter is more desirably 150 nm or less and yet more desirably 125 nm or less.

### (1.3.5. Pore Volume)

A “pore volume” means a value calculated from the amount of nitrogen absorbed at P/P₀=0 to 0.95 in a nitrogen adsorption isotherm of C/SiC composite particles.

If a pore volume of C/SiC composite particles is too small, catalyst particles are hardly supported in pores. A desirable pore volume therefore is 0.5 cc/g or more.

On the other hand, if a pore volume is too large, the proportion of the volume of pore walls to the volume of C/SiC composite particles is small, the strength of a pore structure is deteriorated, and endurance may sometimes be a concern. A desirable pore volume therefore is 2.0 cc/g or less.

### (2. Electrode Catalyst)

An electrode catalyst according to the present invention includes:
the C/SiC composite particles according to the present invention; and
catalyst particles supported on the surfaces of the C/SiC composite particles.

### (2.1. C/SiC Composite Particles)

In the electrode catalyst according to the present invention, C/SiC composite particles according to the present invention are used for a catalyst carrier. The details of the C/SiC composite particles are as described above and hence the explanations are omitted.

### (2.2. Catalyst Particles)

Catalyst particles are supported on the surfaces of C/SiC composite particles.

Here, “surfaces” of C/SiC composite particles that support catalyst particles mean outer surfaces and/or inner surfaces of pores of porous carbon particles. In order to reduce catalyst poisoning, it is desirable that catalyst particles are supported in pores of porous carbon particles.

In the present invention, a material for catalyst particles is not particularly limited as long as the material shows oxygen reduction reaction activity or hydrogen oxidation reaction activity. Examples of a material for catalyst particles are:
(a) precious metals (Pt, Au, Ag, Pd, Rh, Ir, Ru, Os);
(b) alloys containing two or more kinds of precious metal elements;
(c) alloys containing one or more kinds of precious metal elements and one or more kinds of base metal elements (for example, Fe, Co, Ni, Cr, V, Ti, etc.);
(d) metal oxynitrides; and
(e) carbon alloys.

### (3. Polymer Electrolyte Fuel Cell)

A polymer electrolyte fuel cell includes a membrane electrode assembly in which a cathode catalyst layer is bonded to one surface and an anode catalyst layer is bonded to the other surface of an electrolyte membrane.

The cathode catalyst layer includes a composite of a cathode catalyst and a catalyst layer ionomer. Then the anode catalyst layer includes a composite of an anode catalyst and a catalyst layer ionomer.

The polymer electrolyte fuel cell according to the present invention includes the electrode catalyst according to the present invention for a cathode catalyst or an anode catalyst. The polymer electrolyte fuel cell according to the present invention may also include the electrode catalyst according to the present invention for both a cathode catalyst and an anode catalyst.

The details of the electrode catalyst are as described above and hence the explanations are omitted.

### (4. Manufacturing Method of Porous Silica Particles (Template))

C/SiC composite particles according to the present invention are manufactured by using porous silica particles as a template. The method for manufacturing porous silica particles according to the present invention includes:
a polymerization process of obtaining precursor particles by polycondensing a silica source in a reaction solution containing the silica source, a surfactant, and a catalyst;
a drying process of separating the precursor particles from the reaction solution and drying the precursor particles; and
a baking process of obtaining mesoporous silica by baking the precursor particles.

The method for manufacturing porous silica particles according to the present invention may further include a diameter expansion process of applying diameter expansion treatment to dried precursor particles.

### (4.1. Polymerization Process)

Firstly, precursor particles are obtained by polycondensing a silica source in a reaction solution containing the silica source, a surfactant, and a catalyst (polymerization process).

### (4.1.1. Silica Source)

In the present invention, the type of a silica source is not particularly limited. Examples of a silica source are:
(a) tetraalkoxysilanes such as tetramethoxysilane, tetraethoxysilane, tetraisopropoxysilane, tetrabutoxysilane, dimethoxydiethoxysilane, and tetraethylene glycoxysilane;
(b) trialkoxysilanes such as 3-mercaptopropyltrimethoxysilane, 3-aminopropyltrimethoxysilane, 3-aminopropyltriethoxysilane, and 3-(2-aminoethyl)aminopropyltrimethoxysilane; and
(c) silicate such as sodium silicate and kanemite.

As a silica source, any one of those may be used or two or more of them may be used in combination.

### (4.1.2. Surfactant)

In the case of polycondensing a silica source in a reaction solution, when a surfactant is added to the reaction solution, the surfactant forms a micelle in the reaction solution. Since hydrophilic groups are gathered around the micelle, the silica source is adsorbed on the surface of the micelle. Further, the micelle adsorbing the silica source self-organizes in the reaction solution and the silica source is polycondensed. As a result, mesopores (including micropores 2 nm or less in diameter, the same shall apply hereinafter) caused by the micelle are formed in the interiors of primary particles. The size of the mesopores can be controlled (1 to up to 50 nm) mainly by the molecular length of the surfactant.

In the present invention, the type of a surfactant is not particularly limited and alkyl quaternary ammonium salt is preferably used as a surfactant. The alkyl quaternary ammonium salt is a chemical compound represented by the following expression;

CH₃—(CH₂)ₙ—N+(R₁)(R₂)(R₃)X⁻. . . (a).

In the expression (a), R₁, R₂, and R₃ represent alkyl groups each of which has a carbon number of 1 to 3, respectively. R₁, R₂, and R₃ may be the same as or different from each other. In order to facilitate the aggregation of alkyl quaternary ammonium salts (formation of micelle), it is desirable that all of R₁, R₂, and R₃ are the same. Further, it is desirable that at least one of R₁, R₂, and R₃ is a methyl group and more desirable that all of R₁, R₂, and R₃ are a methyl group.

In the expression (a), X represents a halogen atom. Type of the halogen atom is not particularly limited but it is desirable that X is Cl or Br for the reason of availability.

In the expression (a), n represents an integer of 7 to 21. Generally, as n is smaller, a spherical mesoporous material in which the central pore diameter of mesopores is smaller is obtained. On the other hand, as n is larger, the central pore diameter is larger. If n is too large, however, hydrophobic interaction of the alkyl quaternary ammonium salt becomes excessive. As a result, a layered compound is generated and a mesoporous material is not obtained. n is desirably 9 to 17 and more desirably 13 to 17.

Among the surfactants represented by the expression (a), alkyltrimethylammonium halide is desirable. Examples of alkyltrimethylammonium halide are hexadecyltrimethylammonium halide, octadecyltrimethylammonium halide, nonyltrimethylammonium halide, decyltrimethylammonium halide, undecyltrimethylammonium halide, dodecyltrimethylammonium halide, and tetradecylammonium halide.

Among them, alkyltrimethylammonium bromide or alkyltrimethylammonium chloride is particularly desirable.

In the case of synthesizing porous silica particles, one or two or more kinds of alkyl quaternary ammonium salts may be used. However, since an alkyl quaternary ammonium salt becomes a template for forming mesopores in primary particles, the type largely influences the shapes of the mesopores. In order to synthesize porous silica particles having more uniform mesopores, it is desirable to use one kind of alkyl quaternary ammonium salt.

### (4.1.3. Catalyst)

When a silica source is polycondensed, usually a catalyst is added in a reaction solution. In the case of synthesizing porous silica particles, alkali such as sodium hydroxide or ammonia water or acid such as hydrochloric acid may be used as a catalyst.

### (4.1.4. Solvent)

As a solvent, water, an organic solvent such as alcohol, a mixed solvent of water and an organic solvent, or the like is used.

As the alcohol, any one of
(1) monohydric alcohol such as methanol, ethanol, and propanol,
(2) dihydric alcohol such as ethylene glycol, and
(3) trihydric alcohol such as glycerin may be acceptable.

### (4.1.5. Composition of Reaction Solution)

A composition of a reaction solution influences an outer shape and a pore structure of synthesized porous silica particles. In particular, a concentration of a surfactant and a concentration of a silica source in a reaction solution largely influence an average particle diameter, pore diameters, a pore volume, and linearity of primary particles of the porous silica particles.

### (A. Concentration of Surfactant)

If a concentration of a surfactant is too low, a surfactant necessary for forming a porous structure is insufficient and the shapes and sizes of primary particles may sometimes become non-uniform. A concentration of a surfactant therefore is desirably 0.003 mol/L or more. A concentration of a surfactant is more desirably 0.0035 mol/L or more and yet more desirably 0.004 mol/L or more.

On the other hand, if a concentration of a surfactant is too high, primary particle diameters may sometimes become excessively large. A concentration of a surfactant therefore is desirably 1.0 mol/L or less. A concentration of a surfactant is more desirably 0.95 mol/L or less and yet more desirably 0.90 mol/L or less.

### (B. Concentration of Silica Source)

If a concentration of a silica source is too low, a surfactant is excessive to the silica source and primary particles may sometimes become excessively large. A concentration of a silica source therefore is desirably 0.05 mol/L or more. A concentration of a silica source is more desirably 0.06 mol/L or more and yet more desirably 0.07 mol/L or more.

On the other hand, if a concentration of a silica source is too high, not particles of small aspect ratios but particles of sheet shapes may sometimes be obtained. A concentration of a silica source therefore is desirably 1.0 mol/L or less. A concentration of a silica source is more desirably 0.95 mol/L or less and yet more desirably 0.9 mol/L or less.

### (C. Concentration of Catalyst)

In the present invention, a concentration of a catalyst is not particularly limited. Generally, if a concentration of a catalyst is too low, the precipitation rate of particles becomes low. On the other hand, if a concentration of a catalyst is too high, the precipitation rate of particles becomes high. It is desirable to select an optimum concentration of a catalyst in accordance with the type of a silica source, the type of a surfactant, a targeted physical property value, and others.

When acid is used as a catalyst for example, it is desirable to adjust the concentration of the catalyst so that pH of a reaction solution may be 9 or lower. The pH of a reaction solution is more desirably 8.5 or lower and yet more desirably less than 5.
On the other hand, when alkali is used as a catalyst, it is desirable to adjust the concentration of the catalyst so that the pH of a reaction solution may be more than 7.

### (4.1.6. Reaction Conditions)

Hydrolysis and polycondensation are performed by adding a silica source in a solvent containing a predetermined amount of surfactant. Consequently, the surfactant functions as a template and precursor particles containing silica and the surfactant are obtained.

With regard to reaction conditions, optimum conditions are selected in accordance with the type of a silica source, the particle diameters of the precursor particles, and others. Generally, a desirable reaction temperature is −20° C. to 100° C. A reaction temperature is more desirably 0° C. to 100° C., yet more desirably 0° C. to 90° C., still yet more desirably 10° C. to 80° C., and yet still yet more desirably 35° C. to 80° C.

### (4.2. Drying Process)

Successively, the precursor particles are separated from the reaction solution and dried (drying process).

The drying is applied in order to remove the solvent remaining in the precursor particles. The drying condition is not particularly limited as long as the solvent can be removed.

### (4.3. Diameter Expansion Treatment)

Successively, diameter expansion treatment may be applied to the dried precursor particles if necessary (diameter expansion process). The “diameter expansion treatment” means a treatment of expanding the diameters of mesopores in primary particles.

Specifically, the diameter expansion treatment is applied by hydrothermally heat-treating the synthesized precursor particles (particles from which the surfactant is not removed) in a solution containing a diameter expander. By this treatment, it is possible to expand the pore diameters of the precursor particles.

Examples of a diameter expander are:
(a) hydrocarbons such as trimethylbenzene, triethylbenzene, benzene, cyclohexane, triisopropylbenzene, naphthalene, hexane, heptane, octane, nonane, decane, undecane, and dodecane; and
(b) acids such as hydrochloric acid, sulfuric acid, and nitric acid.

Pore diameters are expanded by hydrothermal treatment under the coexistence of hydrocarbon. This is probably because silica rearrangement occurs when a diameter expander is introduced from a solvent into pores of more hydrophobic precursor particles.

Further, pore diameters are expanded by hydrothermal treatment under the coexistence of acid such as hydrochloric acid. This is probably because dissolution/reprecipitation of silica progresses in the interiors of primary particles. When manufacturing conditions are optimized, radial pores are formed in the interior of silica. When hydrothermal treatment is applied to it under the coexistence of acid, dissolution/reprecipitation of silica occurs and the radial pores are converted to communicating pores.

The conditions of the diameter expansion treatment are not particularly limited as long as target pore diameters are obtained. Usually, it is desirable to add a diameter expander of about 0.05 mol/L to 10 mol/L to a reaction solution and apply hydrothermal treatment at 60° C. to 150° C.

### (4.4. Baking Treatment)

Successively, after the diameter expansion treatment is applied as needed, the precursor particles are baked (baking process). Consequently, porous silica particles according to the present invention are obtained.

The baking is performed to dehydrate/polymerize the precursor particles in which an OH group remains and to thermally decompose the surfactant remaining in the mesopores. The baking conditions are not particularly limited as long as dehydration/crystallization and thermal decomposition of the surfactant can be performed. Usually, the baking is applied by heating the precursor particles at 400° C. to 800° C. for 1 to 10 hours in the atmosphere.

### (5. Manufacturing Method of C/SiC Composite Particles)

A method for manufacturing C/SiC composite particles according to the present invention includes:
a first process of preparing porous silica particles acting as a template;
a second process of precipitating carbon in pores of the porous silica particles and obtaining a silica/carbon composite A;
a third process of removing a part of the silica from the silica/carbon composite A and obtaining a silica/carbon composite B; and
a fourth process of obtaining the C/SiC composite particles according to the present invention by heat-treating the silica/carbon composite B and graphitizing the carbon and simultaneously reacting the silica with a part of the carbon and generating SiC.

A method for manufacturing C/SiC composite particles according to the present invention may further include a fifth process of performing activation treatment to introduce a —OH group and/or a —COOH group on the surfaces of the porous carbon particles after the fourth process.

### (5.1. First Process (Manufacturing Template))

Firstly, porous silica particles acting as a template are prepared (first process). The details of the method for manufacturing porous silica particles are as described above and hence the explanations are omitted.

(5.2. Second Process (Carbon Precipitation into Pores))

Successively, carbon is precipitated in pores of the porous silica particles and a silica/carbon composite A is obtained (second process).

The precipitation of carbon in pores is performed concretely by:
(a) introducing a carbon precursor into pores; and
(b) polymerizing and carbonizing the carbon precursor in the pores.

### (5.2.1. Introduction of Carbon Precursor)

A “carbon precursor” means a substance that can produce carbon by thermal decomposition. Concrete examples of such a carbon precursor are:
(1) a thermopolymerizable polymer precursor that is a liquid at room temperature (for example, furfuryl alcohol, aniline, etc.);
(2) a mixture of an aqueous solution of carbohydrate and acid (for example, a mixture of a monosaccharide such as sucrose, xylose, or glucose, a disaccharide, or a polysaccharide and acid such as sulfuric acid, hydrochloric acid, nitric acid, or phosphoric acid); and
(3) a mixture of two-component curable polymer precursors (for example, phenol and formalin).

Among those, a polymer precursor can be filled into pores without being diluted with a solvent and hence can generate a relatively large amount of carbon in pores with a relatively small number of fillings. Further, it has the advantages of not requiring a polymerization initiator and being easy to handle.

When a carbon precursor of a liquid or a solution is used, the larger the amount of the liquid or the solution adsorbed at one time, the better, and an amount that allows the entire pores to be filled with the liquid or the solution is preferable.

Further, when a mixture of an aqueous solution of a carbohydrate and acid is used as a carbon precursor, it is preferable that the amount of the acid is a minimum amount that can polymerize an organic matter.

Furthermore, when a mixture of two-component curable polymer precursors is used as a carbon precursor, an optimum ratio is selected in accordance with the types of the polymer precursors.

### (5.2.2. Polymerization and Carbonization of Carbon Precursor)

Successively, the polymerized carbon precursor is carbonized in the pores. The carbonization of the carbon precursor is performed by heating porous silica particles containing the carbon precursor to a predetermined temperature in a nonoxidizing atmosphere (for example, in an inert atmosphere or in vacuum). A desirable heating temperature is concretely 500° C. or higher to 1,200° C. or lower. If the heating temperature is lower than 500° C., the carbonization of the carbon precursor becomes insufficient. On the other hand, if the heating temperature exceeds 1,200° C., silica reacts with carbon undesirably. As the heating time, an optimum time is selected in accordance with the heating temperature.

Here, the amount of carbon generated in pores may be any amount as long as the amount is not less than an amount of allowing carbon particles to maintain their shapes when a part of the silica is removed. When the amount of carbon generated through a single filling, polymerization, and carbonization is relatively small therefore, it is desirable to repeat those processes multiple times. On this occasion, the conditions of repeated processes may be the same or different.

Further, when the processes of filling, polymerization, and carbonization are repeated multiple times, in the carbonization process, it is also possible to apply carbonization treatment at a relatively low temperature and, after the last carbonization treatment is finished, apply carbonization treatment again at a temperature higher than the previous temperature. When the last carbonization treatment is applied at a temperature higher than the temperature of the previous carbonization process, it becomes easier to integrate the carbon introduced into the pores in multiple times.

### (5.3. Third Process (Partial Removal of Template))

Successively, a part of silica is removed from the silica/carbon composite A (third process). Consequently, a silica/carbon composite B having a silica content smaller than the silica/carbon composite A is obtained.

Concrete examples of a method for removing a part of silica are:
(1) a method of heating the silica/carbon composite A in an alkaline aqueous solution such as sodium hydroxide; and
(2) a method of etching the silica/carbon composite A in a hydrofluoric acid aqueous solution.

On this occasion, by optimizing the composition and temperature of the aqueous solution, a treatment time, and others, a silica/carbon composite B in which a part of the silica remains in the pores of the porous carbon particles is obtained.

The amount of silica remaining in the pores affects the characteristics of C/SiC composite particles. Generally, if the amount of remaining silica is too small, the amount of SiC particles generated in the pores of the porous carbon particles becomes excessively small. On the other hand, if the amount of remaining silica is too large, a large amount of carbon is consumed for generating SiC particles and the pore structure of the porous carbon particles may sometimes be broken. In the third process therefore, it is preferable to remove a part of silica from the silica/carbon composite A so that the Si mass rate of the C/SiC composite particles may be more than 0 mg/m² to not more than 6.8 mg/m².

### (5.4. Fourth Process (Generation of SiC Particles))

Successively, SiC is generated by heat-treating the silica/carbon composite B, graphitizing carbon, and simultaneously reacting silica with a part of carbon (fourth process). Consequently, C/SiC composite particles according to the present invention are obtained.

It is acceptable that a heat treatment temperature is higher than or equal to the temperature at which SiC particles are generated. Generally, if a heat treatment temperature is too low, SiC is not generated within a practical treatment time. A heat treatment temperature therefore is desirably 1,300° C. or higher and more desirably 1,400° C. or higher.

On the other hand, if a heat treatment temperature is too high, SiC may sometimes be decomposed. A heat treatment temperature therefore is desirably 2,300° C. or lower and more desirably 2,000° C. or lower.

It is preferable that the fourth process is a process of heat-treating a silica/carbon composite B in an inert gas atmosphere or in vacuum.

When heat treatment is applied in an inert gas atmosphere, the reactions represented mainly by the following expressions (1) and (2) are expected to occur. On this occasion, if more carbon is consumed for generating SiC, the pore structure is more likely to be broken;

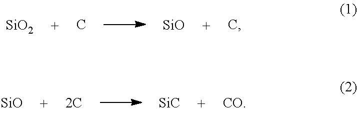

On the other hand, when heat treatment is applied in vacuum, SiO generated through the reaction of the expression (1) is vaporized and the reaction of the expression (2) is less likely to occurs. As a result, the consumption of carbon is reduced and the amount of generated SiC is also reduced.

With regard to the temperature and atmosphere during heat treatment therefore, it is preferable to select an optimum temperature and atmosphere in consideration of those points. In particular, it is preferable to select the temperature and atmosphere during heat treatment so that the Si mass rate of the C/SiC composite particles may be more than 0 mg/m² to not more than 6.8 mg/m².

### (5.5. Fifth Process (Activation Treatment))

Successively, activation treatment of introducing a —OH group and/or a —COOH group onto the surfaces of porous carbon particles is applied as needed (fifth process). When activation treatment is applied, the surfaces (outer surfaces and inner surfaces in pores) of the porous carbon particles are hydrophilized. As a result, it becomes easier to support fine catalyst particles in the pores.

The activation treatment is not particularly limited as long as it can introduce a —OH group and/or a —COOH group onto the surfaces of porous carbon particles. An example of an activation treatment method is a method of oxidizing the carbon particle surfaces with an oxidant. Examples of an oxidant are air, oxygen, ozone, hydrogen peroxide, and nitric acid.

### (6. Effects)

When a part of silica is removed from a silica/carbon composite and the silica/carbon composite is heat-treated at a relatively high temperature, the carbon is graphitized, simultaneously the silica reacts with the carbon, and SiC is generated. As a result, a C/SiC composite in which SiC particles are dispersed on inner wall surfaces of pores of porous carbon particles is obtained.

SiC particles have the function of decomposing hydrogen peroxide into harmless water and oxygen. When catalyst particles are supported on the surfaces (for example, inner wall surfaces of pores) of C/SiC composite particles therefore, even though the hydrogen peroxide is generated on the surfaces of the catalyst particles, the SiC particles existing in the pores decompose the hydrogen peroxide rapidly. As a result, it is possible to suppress the deterioration of an electrolyte caused by peroxide radicals.

Further, a decomposition product (for example, sulfonic acid anion) generated by the deterioration of an electrolyte can be a poisoning source of the catalyst particles. In the case where the catalyst particles are supported in the pores of the C/SiC composite particles in contrast, the poisoning of the catalyst particles by the poisoning source can be suppressed.

When an electrode catalyst in which catalyst particles are supported in the pores of C/SiC composite particles is used as a cathode catalyst or an anode catalyst of a polymer electrolyte fuel cell, contact between the catalyst particles in the pores and a catalyst layer ionomer is avoided and hence a high catalyst activity is obtained.

Further, hydrogen peroxide generated during an open circuit and power generation is one of the causative substances that deteriorate an electrolyte membrane. In the C/SiC composite particles according to the present invention, SiC particles that work as a catalyst to decompose hydrogen peroxide are distributed on the inner surfaces of the pores of porous carbon particles and hence the deterioration of an electrolyte membrane caused by hydrogen peroxide can be suppressed. Further, free sulfonic acid anions generated by the deterioration of an electrolyte are reduced and poisoning of catalyst particles by the sulfonic acid anions is also reduced. The deterioration of catalyst activity with the lapse of time therefore can be suppressed.

### EXAMPLES

### Examples 1 to 4, Comparative Example 1

### (1. Manufacturing C/SiC Composite Particles)

### (1.1.1. Synthesis of Template Silica)

Table 1 shows raw material compositions for synthesizing template silica. The template silica is synthesized in accordance with the following procedure.

TABLE 1

| | | Examples 1 and 2, | |
|---|---|---|---|
| | | Comparative | Examples |
| | | Example 1 | 3 and 4 |
| | Reagent | Composition/g | Composition /g |
| Solution | 30 wt % | 4.1 | 32.1 |
| A | cetyltrimethylammonium | | |
| | chloride aqueous solution | | |
| | Methanol | 4.6 | 84.1 |
| | EG | 4.6 | 84.1 |
| | Water | 41.8 | 310.4 |
| | 1N NaOH | 5.3 | 9.4 |
| Solution | TEOS | 10.0 | 10.0 |
| B | Methanol | 5.3 | 20.7 |
| | EG | 5.3 | 20.7 |

Firstly, a 30 mass % cetyltrimethylammonium chloride aqueous solution was used as the surfactant. Predetermined amounts of water, methanol, and ethylene glycol (hereinafter referred to also as “EG”) were added to a predetermined amount of surfactant aqueous solution and stirred. A predetermined amount of 1 N sodium hydroxide aqueous solution was added to the mixture as a hydrolysis catalyst of a silica source and the solution A was obtained.

Apart from this, a predetermined amount of tetraethoxysilane (hereinafter referred to also as “TEOS”) was dispersed as a silica source in a mixed solvent of predetermined amounts of methanol and EG and the solution B was obtained.

The solution B was added to the solution A and stirred for six hours at room temperature. After left overnight, the solution was sucked and filtered. The filtered residue was dispersed in distilled water and washed by ultrasonic treatment. The filtered residue was further recovered by sucking and filtering and dried in a drier of 45° C. overnight.

Successively, for adjusting the pore diameters, a dried silica precursor was dispersed in IN sulfuric acid. Then the solution was contained in a pressure-resistant vessel and subjected to hydrothermal treatment at 120° C. for 68 hours. Successively, after filtered and washed similarly to the above, the silica precursor was baked by being heated from room temperature to 550° C. over two hours and retained at 550° C. for six hours in the atmosphere and a template silica was obtained.

### (1.1.2. Precipitation of Carbon)

The template silica was weighed in a PFA container, furfuryl alcohol (hereinafter referred to also as “F-AL”) of an amount equivalent to the pore volume obtained by measuring the amount of nitrogen adsorption was added, and they were sealed. After filling the pores in the template silica with F-AL by shaking the container, the F-AL was polymerized by heating the template silica for 18 hours in an oven of 150° C. Further, with a tube furnace, the F-AL was carbonized by being heated from room temperature to 500° C. over two hours and being retained at 500° C. for six hours under a nitrogen flow (1 L/min).

After the first carbonization, the similar treatment was performed again with a half amount of the F-AL. The heat treatment, however, was carried out by being heated at 500° C. for six hours, successively further heated to 900° C. over two hours, and retained at 900° C. for six hours.

Finally, in order to partially remove the template silica, a predetermined concentration of hydrofluoric acid (HF) or sodium hydroxide (NaOH) was added to the carbonized specimen and they were stirred for three hours. Here, in order to manufacture carbon with different amounts of residual Si, the template silica was partially removed while the treatment conditions (the concentration of HF or NaOH in the treatment solution and/or the temperature of the treatment solution) were changed.

After the template silica was partially removed, a filtered residue was recovered by sucking and filtering. Further, the filtered residue was washed with water by ultrasonic treatment, recovered again by sucking and filtering, and dried in a drier of 45° C. overnight. Table 2 shows the amounts of residual Si (X-ray fluorescence analysis values) after the partial removal of the template silica.

TABLE 2

| | | | | | Compar- |
|---|---|---|---|---|---|
| | | | | | ative |
| | Exam- | Exam- | Exam- | Exam- | Exam- |
| | ple 1 | ple 2 | ple 3 | ple 4 | ple 1 |
| Residual Si amount | 0.64 | 1.05 | 0.37 | 0.37 | 5.48 |
| (mass %) | | | | | |

### (1.1.3. Graphitization of Carbon)

Graphitization treatment was applied to the obtained silica/carbon composite and C/SiC composite particles were obtained. The temperature of the graphitization treatment was set to 1,900° C. Further, the atmosphere during the graphitization treatment was an Ar atmosphere (Examples 1 to 3 and Comparative Example 1) or vacuum (Example 4).

### (2. Test Method)

### (2.1. Nitrogen Adsorption Isotherm)

In order to investigate the difference in pore structure after graphitization with respect to the amount of residual Si, nitrogen adsorption isotherms of C/SiC composite particles were measured and pore distributions were obtained by BJH analysis.

### (2.2. Si Mass Rate)

X-ray fluorescence analysis (XRF) was applied to the C/SiC composite particles and an Si mass rate was calculated.

### (3. Results)

### (3.1. Nitrogen Adsorption Isotherm)

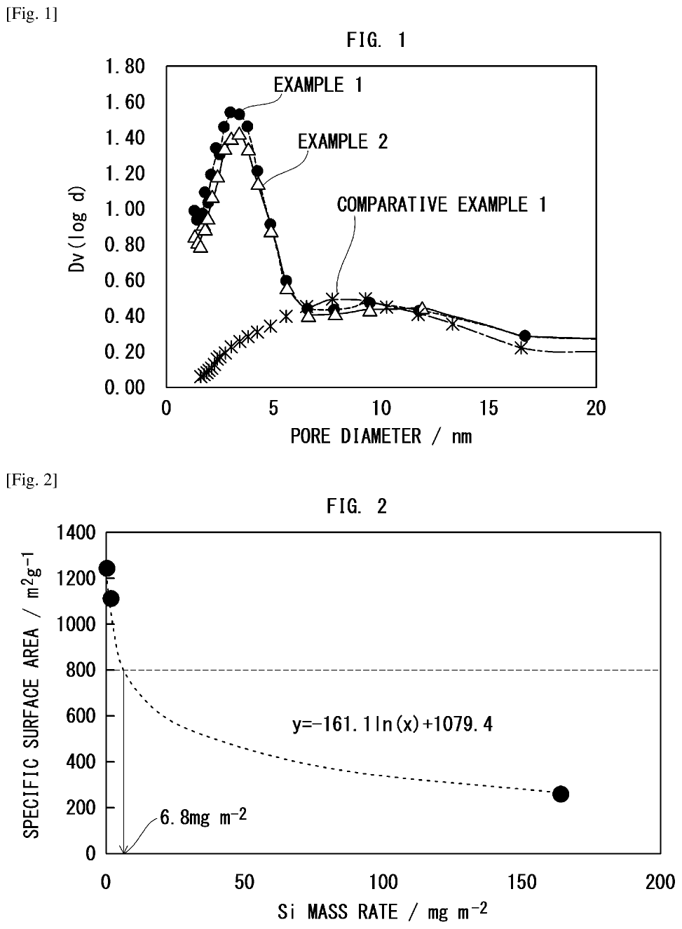

FIG. 1 illustrates pore diameter distributions of C/SiC composite particles obtained in Examples 1 and 2 and Comparative Example 1. Pores with pore diameters of 3 nm to 4 nm remained in Examples 1 and 2. On the other hand, pores with pore diameters of 3 nm to 4 nm disappeared in Comparative Example 1. This is probably because the pore walls of the porous carbon particles reacted with a large amount of residual silica and the pore structure was broken.

### (3.2. Si Mass Rate)

FIG. 2 illustrates the relationship between an Si mass rate (an Si mass per unit surface area of C/SiC composite particles) and a specific surface area of C/SiC composite particles. It is found from FIG. 2 that a specific surface area of C/SiC composite particles is reduced as an Si mass rate increases. Further, it is also found that an Si mass rate should be 6.8 mg/m² or less in order to obtain a specific surface area of 800 m²/g or more required for a catalyst carrier.

### Examples 3 and 4, Comparative Example 2

### (1. Manufacturing Specimen)

### (1.1. Manufacturing Electrode Catalysis)

As the catalyst carriers, those manufactured by applying air activation to C/SiC composite particles obtained in Examples 3 and 4 were used. The conditions of the air activation were at 480° C. for one hour. Further, for comparison, commercially available porous carbon was used as it was for the catalyst carrier (Comparative Example 2).

Electrode catalysts were obtained by supporting catalyst particles on the surfaces of the catalyst carriers. As the catalyst particles, a platinum alloy catalyst was used. The amount of each of the supported catalysts was set to 40 mass %.

### (1.2. Manufacturing Catalyst Layer)

Each of the obtained electrode catalysts and an ionomer were dispersed in a solvent and catalyst ink was manufactured. A catalyst layer was obtained by applying the catalyst ink on a polytetrafluoroethylene sheet with an applicator and drying them in the atmosphere.

### (1.3. Manufacturing MEA)

An MEA was manufactured by transferring a cathode catalyst layer and an anode catalyst layer to an electrolyte membrane by hot press.

Here, as the electrolyte membrane, a fluorinated polymer membrane (NR 211) was used. As the cathode catalyst layer, a catalyst layer manufactured in (1.2.) was used. Further, as the anode catalyst layer, a catalyst layer manufactured by using commercially available Pt/C catalyst and an ionomer was used.

(2. Test method)

### (2.1. Si Mass Rate)

X-ray fluorescence analysis (XRF) was applied to the C/SiC composite particles after the catalyst was supported and an Si mass rate was calculated.

### (2.2. Cell Evaluation)

A unit cell was manufactured by using an obtained MEA. After the unit cell was subjected to conditioning operation, initial I-V characteristics and electrode characteristics (cyclic voltammogram) were evaluated. Successively, an endurance test was applied and performance after the endurance test was evaluated. The details of the evaluation are as follows.

### (2.2.1. Unit Cell)

A unit cell was manufactured by arranging diffusion layers and current collectors on both sides of an MEA, respectively. The details of the unit cell are as follows;
cell: square cell for 1 cm²,
diffusion layer: carbon paper (with microporous layer),
current collector: gold-plated copper plate with integrated flow path.

### (2.2.2. Conditioning Operation)

The unit cell was subjected to conditioning operation by voltage sweep. The conditions are as follows;
cell temperature/relative humidity (both electrodes): 60° C./80% RH,
air electrode gas: air, 1,000 mL/min, atmospheric pressure,
fuel electrode gas: H2, 500 mL/min, atmospheric pressure,
voltage sweep: sweep is applied at 50 mV/s from an open circuit voltage to −0.1 V and repeated until an I-V curve does not change.

### (2.2.3. Power Generation Performance Evaluation)

An I-V curve was measured by voltage sweep. The measurement conditions are as follows;
cell temperature/relative humidity (both electrodes): 60° C./80% RH,
air electrode gas: air, 1,000 mL/min, atmospheric pressure,
fuel electrode gas: H2, 500 mL/min, atmospheric pressure,
voltage sweep: sweep is applied at 10 mV/s from an open circuit voltage to −0.1 V three times (third data is adopted).

### (2.2.4. Cyclic Voltammogram (CV) Measurement)

A CV was measured under the following conditions;
cell temperature/relative humidity (both electrodes): 60° C./80% RH,
air electrode gas: N2, 1,000 mL/min,
fuel electrode gas: H2, 500 mL/min,
voltage range: 115 to 1,000 mV,
sweep speed: 50 mV/s,
number of cycles: 10.

### (2.2.5. Endurance Test)

An open circuit test and a wet and dry test were applied alternately under the following conditions;

### (A. Conditions of Open Circuit Test)

cell temperature/relative humidity (both electrodes): 82° C./30% RH,
air electrode gas: air, 400 mL/min,
fuel electrode gas: H2, 100 mL/min,

### (B. Wet and Dry Test)

cell temperature/relative humidity (both electrodes): humidification at 60° C./80%
RH and no humidification at 60° C. are conducted in a one-minute cycle,
air electrode gas: N2, 500 mL/min,
fuel electrode gas: N2, 500 mL/min.

### (3. Results)

### (3.1. I-V Characteristics)

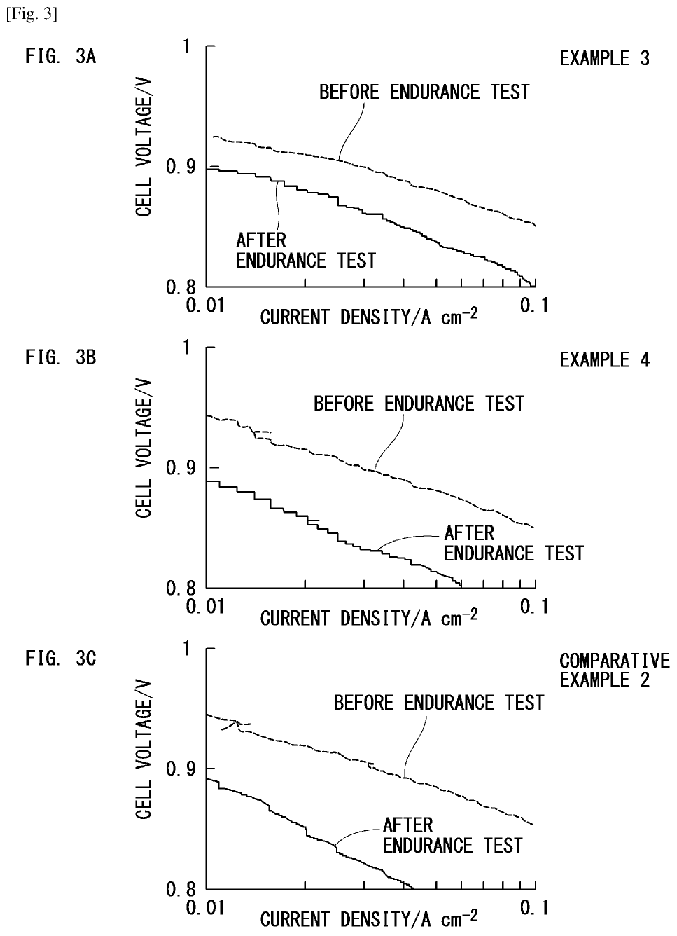

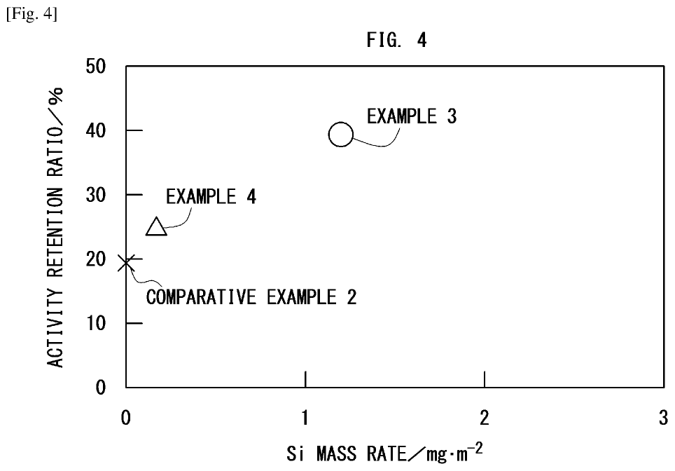

FIGS. 3A, 3B, and 3C illustrate I-V characteristics of the unit cells before and after the endurance test obtained in Examples 3 and 4 and Comparative Example 2, respectively. FIG. 4 illustrates the relationship between an Si mass rate (Si mass per unit surface area of C/SiC composite particles) and an activity retention ratio. The “activity retention ratio” means a ratio of a mass activity (a value obtained by dividing a current value at 0.9 V in the I-V characteristics by a Pt mass) after the endurance test to a mass activity before the endurance test.

Further, Table 3 shows Si mass rates of the C/SiC composite particles including catalysts particles obtained in Examples 3 and 4. From FIGS. 3 and 4 and Table 3, it is found that the activity reduction after the endurance test becomes smaller as the Si mass rate increases. This is probably because SiC existing in the pores of porous carbon particles decomposes hydrogen peroxide and contributes to the improvement of endurance.

TABLE 3

| | Example 3 | Example 4 |
|---|---|---|
| Si mass rate | 1.19 mg/m² | 0.17 mg/m² |

### (3.2. CV)

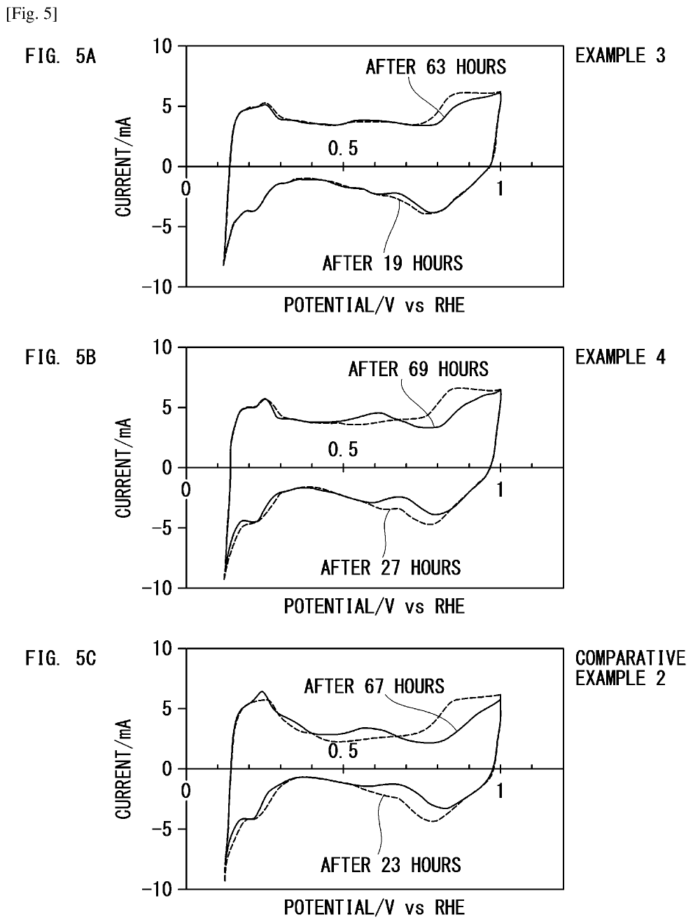

FIGS. 5A, 5B, and 5C illustrate CVs during an endurance test of unit cells obtained in Examples 3 and 4 and Comparative Examples 2, respectively. In FIG. 5, CVs when OC integration time is 19 to 27 hours (described as “after 27 hours” and the like) and when OC integration time is 63 to 69 hours (described as “after 69 hours” and the like) are shown, respectively. From FIG. 5, it is found that:
(a) rise of Pt oxidation current of 0.7 V or more of CV when the OC integration time is 63 to 69 hours shifts to the higher potential side than that when the OC integration time is 19 to 27 hours; and
(b) the shift is larger as the Si mass rate reduces.

As a cause of the shift of oxidation current, it is considered that the free sulfonic acid anion generated by electrolyte deterioration in the endurance test is adsorbed on the Pt surface. It is suggested therefore that electrolyte deterioration is more likely to be generated as the Si mass rate is smaller.

From the above results, it was found that catalyst poisoning caused by electrolyte deterioration was suppressed more as the Si mass rate was larger.

The embodiments according to the present invention have heretofore been explained in detail but the present invention is not limited by the embodiments at all and can be modified variously within the range not departing from the tenor of the present invention.

### INDUSTRIAL APPLICABILITY

The C/SiC composite particles according to the present invention can be used as a catalyst carrier of an air electrode catalyst layer or a catalyst carrier of a fuel electrode catalyst layer in a polymer electrolyte fuel cell.

1. C/SiC composite particles, comprising:
porous carbon particles; and
SiC particles distributed on inner wall surfaces of pores of the porous carbon particles.

2. The C/SiC composite particles according to claim 1, wherein a mode diameter of the pores of the porous carbon particles is 1.5 nm or more to 5.0 nm or less.

3. The C/SiC composite particles according to claim 1, wherein an average primary particle diameter of the SiC particles is the mode diameter or less of the pores of the porous carbon particles.

4. The C/SiC composite particles according to claim 1, wherein an Si mass rate is more than 0 mg/m² to not more than 6.8 mg/m², the “Si mass rate” meaning a rate of the mass of Si per unit surface area of the C/SiC composite particles.

5. The C/SiC composite particles according to claim 1, wherein an average primary particle diameter is 50 nm or more to 200 nm or less.

6. The C/SiC composite particles according to claim 1, wherein a pore volume is 0.5 cc/g or more to 2.0 cc/g or less.

7. The C/SiC composite particles according to claim 1, further comprising a —OH group and/or a —COOH group introduced on the surfaces of the porous carbon particles.

8. A method for manufacturing C/SiC composite particles, comprising:
a first process of preparing porous silica particles acting as a template;
a second process of precipitating carbon in pores of the porous silica particles and obtaining a silica/carbon composite A;
a third process of removing a part of the silica from the silica/carbon composite A and obtaining a silica/carbon composite B; and
a fourth process of obtaining the C/SiC composite particles according to claim 1 by heat-treating the silica/carbon composite B and graphitizing the carbon and simultaneously reacting the silica with a part of the carbon and generating SiC.

9. The method for manufacturing a C/SiC composite according to claim 8, wherein the third process includes a process of removing a part of the silica from the silica/carbon composite A so that an Si mass rate of the C/SiC composite particles is more than 0 mg/m² to not more than 6.8 mg/m².

10. The method for manufacturing C/SiC composite particles according to claim 8, wherein the fourth process includes a process of heat-treating the silica/carbon composite B at a temperature of 1,300° C. or higher to 2,300° C. or lower.

11. The method for manufacturing C/SiC composite particles according to claim 8, wherein the fourth process includes a process of heat-treating the silica/carbon composite B in an inert gas atmosphere or under vacuum.

12. The method for manufacturing C/SiC composite particles according to claim 8, further comprising a fifth process of performing activation treatment to introduce a —OH group and/or a —COOH group on the surfaces of the porous carbon particles after the fourth process.

13. An electrode catalyst, comprising:
the C/SiC composite particles according to claim 1; and
catalyst particles supported on the surfaces of the C/SiC composite particles.

14. A polymer electrolyte fuel cell including the electrode catalyst according to claim 13 as a cathode catalyst or an anode catalyst.
